(19) United States
(12) Patent Application Publication
(10) Pub. No.: US 2021/0179149 A1
(43) Pub. Date: Jun. 17, 2021

(54) CONVEYOR SYSTEM HAVING A CONVEYOR CARRIAGE

(71) Applicant: EISENMANN SE, Böblingen (DE)

(72) Inventor: Martin Riegraf, Reutlingen (DE)

(21) Appl. No.: 17/048,853

(22) PCT Filed: Apr. 12, 2019
(86) PCT No.: PCT/EP2019/059523

§ 371 Date: Feb. 19, 2021

(30) Foreign Application Priority Data
Apr. 20, 2018 (DE) 10 2018 109 584.8

(51) Int. Cl. B61C 13/00; B61C 3/00

(52) U.S. Cl. CPC B61C 13/00; B61C 3/00

(57) ABSTRACT

A conveyor system, comprising a conveying section and at least one conveyor carriage that carries a drive of its own, and with the drive is movable along the conveying section, wherein the drive includes a drive motor and a separation device, by means of which the power flow between the drive motor and the conveying section can be separated. In order to move a left-behind conveyor carriage out of a difficult-to-reach segment of the conveying section, the separation device is configured to be activated by a separating carriage that follows the conveyor carriage along the conveying section and/or precedes the conveyor carriage along the conveying section in order to separate the power flow between the drive motor of the at least one conveyor carriage and the conveying section.

### BACKGROUND OF THE INVENTION

### 1. Field of the Invention

The invention relates to a conveyor system, having:

a) a conveyor path and

b) at least one conveyor carriage which carries an individual drive and which can be moved therewith along the conveyor path, wherein the drive comprises
a drive motor and
a separation device, by means of which the force path between the drive motor and the conveyor path can be separated.

The invention further relates to a conveyor carriage for such a conveyor system and a method for removing a conveyor carriage which has remained at a standstill from a poorly accessible conveyor path portion of a conveyor system.

### 2. Description of the Prior Art

In conveyor systems which use conveyor carriages having an individual carried drive, by means of which the conveyor carriages move more or less independently along a fixed conveyor path, there may occur on an individual conveyor carriage malfunctions, as a result of which the conveyor carriage comes to a standstill in any portion of the conveyor path. Of course, this leads to a blockage of the following conveyor carriages on the conveyor path so that the malfunction has to be resolved as quickly as possible.

Generally, those malfunctions which lead to a complete movement failure of a conveyor carriage result from a problem with the components of the drive. In particular in the drive electronic components, such as, for example, sensors, of the drive control units often fail. The mechanical portion of the drive, such as, for example, a drive wheel of the chassis or a toothed wheel of a gear mechanism is not normally responsible for the failure.

In order to guide such a conveyor carriage in which the drive has failed out of the conveyor path, the drive until now comprises between a drive motor and a drive wheel a coupling, in most cases together with a gear mechanism which is in any case required and by means of which the force path between the drive motor and the drive wheel can be separated. The operators can then move the conveyor carriage by means of external manual application of force along the conveyor path onto a maintenance portion so that the conveyor system as a whole can be operated again without the failed conveyor carriage. After separation of the force path, the coupling consequently enables a movement of the conveyor carriage, even when the drive motor is without power, whereby as a mechanical brake it blocks the movement of the conveyor carriage.

In this case, the coupling has previously been activated manually by activating a lever on a gear mechanism housing which also comprises the coupling. This activation of the coupling can be carried out by operators by hand or an activation rod at the site of the failure of the conveyor carriage along the conveyor path.

Furthermore, it is also known to activate such couplings by means of fixedly arranged slotted guiding members which act on the lever of the coupling. This is, for example, necessary when the position of the conveyor carriage is intended to be determined by means of an external positioning unit, for example, in a lifting table or the like. When such a portion is left, the force path is reproduced with a complementary slotted guiding member.

The manual activation which has been explained above for the malfunction functions well in many regions along the conveyor path as long as the coupling in these regions can be readily reached by the operators and the conveyor carriage can be moved in these regions by the force of the operators.

However, regions along the conveyor path in which an activation of the coupling by the operators is not possible or is possible only with the acceptance of risk to the operators are problematic. Such regions are, for example, conveyor path portions over floor openings, regions in narrow housings, and/or regions with an environment which is hazardous to health (vapors, temperature, noise, pressure, darkness, etcetera). Such conveyor path portions which are difficult to access are located in surface processing systems, for example, in the form of dryers, painting sections, assembly lines and/or buffer sections.

### STATEMENT OF INVENTION

An object of the invention is therefore to improve a conveyor system of the type mentioned in the introduction in such a manner that conveyor carriages which have come to a standstill as a result of a malfunction can be more easily removed from poorly accessible conveyor path portions.

An object of the invention is also accordingly to develop a conveyor carriage and to set out an associated method.

This is achieved according to the invention by means of a conveyor system of the type mentioned in the introduction, in which:

c) the separation device is configured to be activated by means of a separation carriage which follows the conveyor carriage along the conveyor path and/or a separation carriage which precedes the conveyor carriage along the conveyor path in order to separate the force path between the drive motor of the at least one conveyor carriage and the conveyor path.

The inventor has recognized that it is not absolutely necessary for the operators to enter the poorly accessible conveyor path portion in order to move conveyor carriages which have come to a standstill at that location manually from this region in the event of a malfunction. Instead, it is advantageous to configure the separation device in such a manner that the separation of the force path between the drive motor and the conveyor path can be activated by another carriage which can move along the conveyor path, the so-called separation carriage.

In this manner, the conveyor path which is present in any case is used in order to reach the region of the conveyor path in which the conveyor carriage which has come to a standstill is located. The fixed conveyor path may, for example, be a travel rail of an electric overhead rail conveyor or a travel rail of an electric floor type conveyor. However, it may also be a normal roadway, for example, a hall floor and/or a storey floor on which conveyor carriages move along with an individual drive.

If the conveyor carriage comprises a plurality of drive motors, of course, the force path can be interrupted for all these drive motors.

Preferably, there is provision for the separation device to comprise a passive activation element which is arranged and configured to be activated by a complementary active activation element on the separation carriage. Such activation elements may be arranged regardless of the position of the main components of the separation device in order to separate the force path close to the end sides of the conveyor carriage or the separation carriage so that a corresponding interaction is possible.

Preferably, there is provision for the active and the passive activation elements to cooperate mechanically. Functions which are carried out mechanically are often less susceptible to failure than functions which are carried out electrically.

Preferably, the activation can be carried out by changing the position and/or location of the passive activation element, for example, by pivoting a lever.

In this instance, transmission elements, such as rods, levers, cables and/or Bowden cables, can be used and transmit the position and/or location change to the separation device. The separation device can thus nonetheless be arranged on the conveyor carriage at positions which are poorly accessible from the front and the rear. In this instance, step-up transmissions and/or step-down transmissions may be provided.

A reversal of the direction of the movement of the passive activation element in order to act on the separation device is also possible.

Finally, during the mechanical activation, the activation forces required should preferably be smaller than the sliding resistance of the stationary conveyor carriage.

Preferably, there is provision for the separation device to comprise an electrical actuation drive in order to separate the force path and for the conveyor carriage to have electrical connection elements which are supplied with electric power by means of complementary electrical connection elements on the separation carriage. An electrical connection between the conveyor carriage which has come to a standstill and the separation carriage can be produced in a simple manner.

In a similar manner, emergency brakes which may be present and which are intended to be unlocked electrically can be deactivated in order to release the movement of the conveyor carriage.

Preferably, there is provision for the separation device to be a switchable coupling, by means of which the force path between the drive motor and a drive wheel which bears on the conveyor path is separated.

In principle, the separation device can separate in any desired manner the force path between the drive motor and the conveyor path. For example, the separation device can lift the drive wheel from the conveyor path by means of a mechanism or drive toothed wheels can be freed from engagement on a toothed rod. However, a switchable coupling is particularly simple. This may in particular be a portion of a gear mechanism which is often present in any case.

Preferably, there is provision for the separation carriage to be another conveyor carriage. The conveyor carriages can thereby be provided at the same time with a separation device and corresponding active and passive activation elements. A conveyor carriage which has come to a standstill can thus be removed from a more poorly accessible conveyor path portion by means of a directly following or preceding conveyor carriage.

Preferably, a conveyor carriage may be provided both with an active and with a passive activation element. The conveyor carriages can thereby all be of the same type. Many of the following developments of the invention are particularly advantageous precisely as a result of the simultaneous construction of the conveyor carriages as separation carriages.

The activation elements may further be arranged at the end sides of the conveyor carriage and complement each other in such a manner that the activation elements can be alternately activated on a correspondingly following or preceding conveyor carriage.

To this end, there may advantageously be provided a blocking mechanism which on a conveyor carriage which is used as a separation carriage (that is to say, on a conveyor carriage which can still be operated normally) blocks the passive capacity for activation of the separation device. This may, for example, be carried out by means of an electrically activated spring bolt which independently places the blockage out of operation in the event of a malfunction on the conveyor carriage.

Another possibility involves active and passive activation elements which operate independently of each other at the two end sides of the conveyor carriage.

Preferably, there is provision, in order to separate the force path, for the separation carriage to be moved closer to the conveyor carriage than is the case during normal travel operation.

This can be carried out by means of the system control unit using an approach travel signal specification to the separation carriage. Preferably, the approach is carried out in this instance by means of a dynamic speed adaptation depending on the spacing of the conveyor carriages relative to each other.

Preferably, there is provision for the drive to comprise a plurality of separation devices and for all these separation devices to be activated at the same time by the separation carriage. To this end, the separation devices are advantageously connected to each other, for example, by means of rods, levers, cables and/or Bowden cables.

Preferably, there is provision for the separation carriage to have a towing and/or pushing device by means of which the conveyor carriage can be towed away or pushed with the separation device of the conveyor carriage being activated at the same time.

Preferably, the towing and/or pushing device engages on components of the conveyor carriage different from the passive activation element. Furthermore, the towing device and/or pushing device may have a pushing face which applies corresponding pressure forces to the conveyor carriage. The pressure forces can then also act at bends of the conveyor path without any positive-locking connection. Tensile forces can in contrast be transmitted by means of corresponding positive-locking or electromagnetic coupling elements.

Preferably, a plurality of separation carriages are used for towing away or pushing if the drive force of a separation carriage is not sufficient. In this instance, one separation carriage can be coupled to the conveyor carriage at the front and one separation carriage can be coupled to the conveyor carriage at the rear.

Preferably, there is provision for the separation carriage to have a signal transmitter which signals successful activation of the separation device of the conveyor carriage to a control unit. For example, the position of the passive activation element on the conveyor carriage can be detected from the separation carriage. However, a corresponding electrical interface between the conveyor carriage and the separation carriage may also be provided.

With regard to the conveyor carriage, the object is achieved with a conveyor carriage which carries an individual drive and which can be moved therewith along a conveyor path, wherein the drive comprises

a) a drive motor and

b) a separation device, by means of which the force path between the drive motor and the conveyor path can be separated.

According to the invention, in this instance

c) the separation device is configured to be activated by a separation carriage which follows the conveyor carriage along the conveyor path and/or a separation carriage which precedes the conveyor carriage along the conveyor path in order to separate the force path between the drive motor of the at least one conveyor carriage and the conveyor path.

With regard to the method, the object is achieved by a method having the following steps:

a) moving the separation carriage toward the conveyor carriage;

b) separating the force path between the drive motor and conveyor path using the separation carriage;

c) moving the conveyor carriage out of the poorly accessible conveyor path portion.

The above-mentioned notions of the invention are not limited to using the separation device on the conveyor carriage only in the event of a malfunction. For example, the separation device can also be used to form pairings comprising a plurality of conveyor carriages, of which only one is driven. This may, for example, be advantageous in buffer regions.

### BRIEF DESCRIPTION OF THE DRAWINGS

Embodiments of the invention are explained in greater detail below with reference to the drawings, in which:

FIG. 1 is a side view of a conveyor system according to the invention with a travel rail and a plurality of conveyor carriages;

FIG. 2 is a cross-section through a dryer portion of the conveyor path;

FIG. 3 is a side view of a conveyor carriage of the conveyor system with a separation device in a first state in which the force path is closed between a drive motor and a drive wheel;

FIG. 4 is a side view of a conveyor carriage of the conveyor system with a separation device in a second state, in which the force path is separated between the drive motor and a drive wheel;

FIG. 5 is a side view of two conveyor carriages which are moved against each other in such a manner that the following conveyor carriage activates the separation device of the preceding conveyor carriage in order to separate the force path;

FIGS. 6a-c show a schematic composition of three states of modified conveyor carriages, whose separation device is configured to be activated or to activate at both sides.

### DESCRIPTION OF PREFERRED EMBODIMENTS

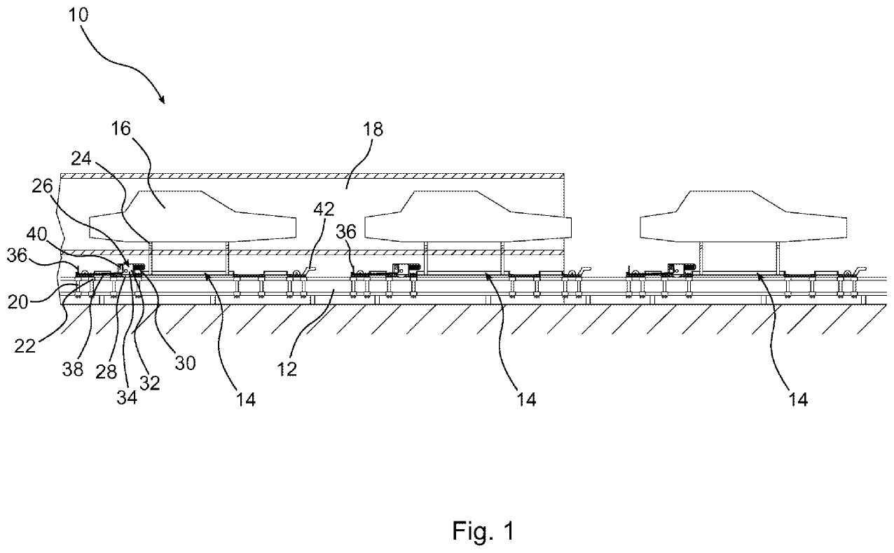

FIG. 1 shows a conveyor system which is generally designated and which is in this instance in the form of an electric monorail floor type conveyor.

The conveyor system 10 has a travel rail 12 which predetermines the conveyor path along which a plurality of conveyor carriages 14 which in this instance transport, for example, a vehicle body 16 or portions thereof can move.

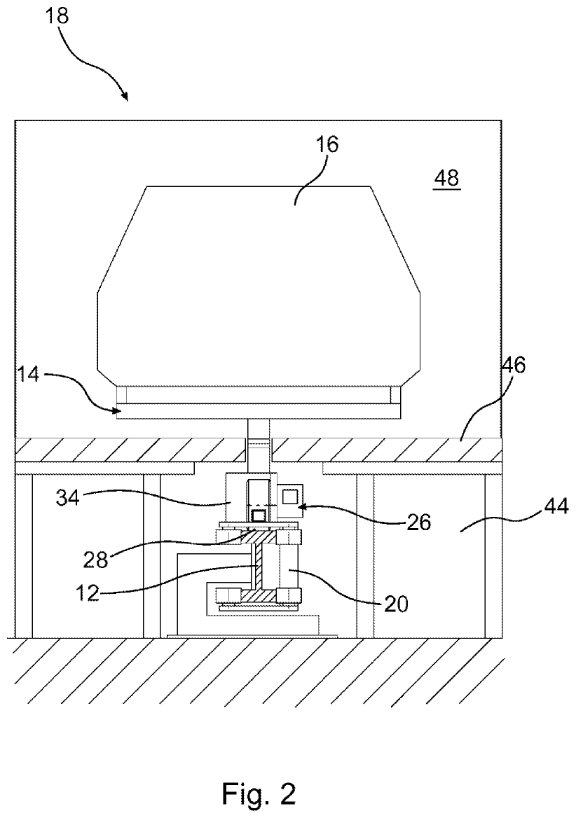

The conveyor system 10 has a dryer 18 as an example of a portion of the conveyor path which is difficult to access. Details in this regard are explained below with reference to FIG. 2.

Each conveyor carriage 14 has a chassis 20 with freely running side wheels 22 which bear on the travel rail 12. There is supported on the chassis 20 a component carrier 24 which carries the vehicle body 16 above the travel rail 12.

Each conveyor carriage 14 further has an individual carried drive 26. This drive comprises a drive wheel 28 and a drive motor 30 which is typically constructed as an electric motor and which is supplied with electric power by means of control and supply sliding rails which are not shown. However, battery-operated drive motors 30 can also be used.

The drive wheel 28, which brings about the movement of the conveyor carriage 14, and the drive motor 30 are connected by means of a gear mechanism 32.

To this end, worm gears are used in most cases and act in a self-locking manner against inherent movements of the conveyor carriage 14 along the conveyor path (for example, in sloping regions of the conveyor path) when the drive motor 30 is not operating. Sometimes the drive 30 may also have blocking brakes which are intended to be unlocked electrically in order to prevent such inherent movements in a reliable manner even in the event of a power failure.

In addition to the gear mechanism 32 or as part of it, the drive 26 has a separation device 34, in this instance in the form of a coupling which is not illustrated in greater detail and by means of which the force path between the drive motor 30 and the conveyor path, that is to say, in this instance, the travel rail 12, can be closed or separated so that the conveyor carriage 14 in the event of a malfunction can be moved freely by means of external application of force.

The separation device 34 has a passive activation element 36 which in this instance is arranged at the rear end of the conveyor carriage 14 and which acts by means of a Bowden cable 38 on a coupling lever 40 of the separation device 34.

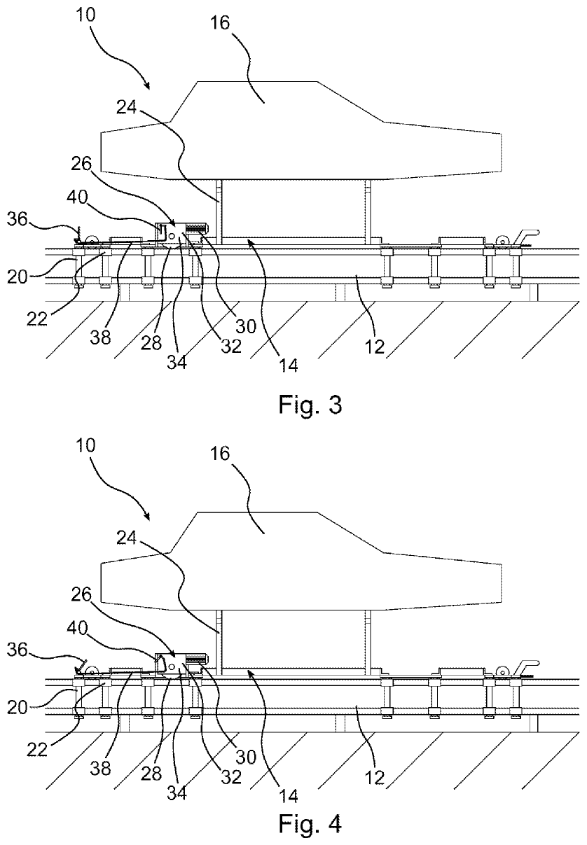

In FIG. 3, the conveyor carriage 14 is shown in a state in which the passive activation element 36 is constructed in this instance by way of example as a rocker lever so that it points straight upward whilst the force path between the drive motor 30 and drive wheel 28 is produced.

At the front end of the conveyor carriage 14 in this case, however, a complementary active activation element 42 (in this instance, in the form of a forwardly protruding rod, an actuator with an extendable rod is also conceivable) is arranged in such a manner that with a sufficiently small spacing between two conveyor carriages 14, by moving the rear conveyor carriage 14 against the preceding conveyor carriage 14, the passive activation element 36 which is arranged at that location is activated.

The active activation element 42 presses in this instance mechanically on the passive activation element 36 and folds it over, whereby the Bowden cable 38 and consequently also the coupling lever 40 moves. This state is shown in FIG. 4.

The conveyor system 10 operates as follows:

As can be seen in FIG. 2, in the dryer portion 18 of the conveyor path the chassis 20, the conveyor carriage 14 together with the travel rail 12 is arranged in a travel space 44 which is delimited by an intermediate floor 46 from the actual dryer tunnel 48. If a conveyor carriage 14 remains at a standstill at that location, the separation device 34 is difficult to access for manual activation.

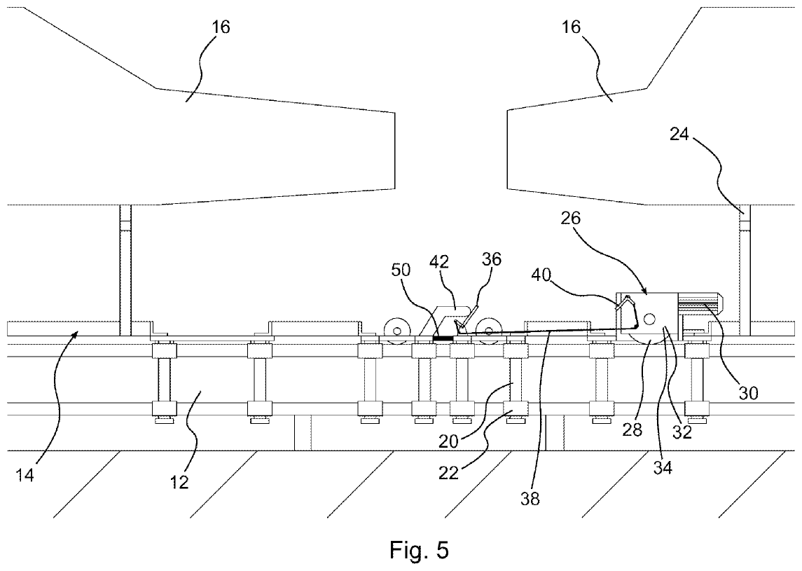

As shown in FIG. 5, therefore, via a system control unit which is not shown the following conveyor carriage 14 is moved closer to the conveyor carriage 14 which has come to a standstill so that the spacing of the two successive conveyor carriages 14 is reduced compared with normal operation.

In this instance, the active activation element 42 of the following conveyor carriage 14 activates the passive activation element 36 and the separation device 34 is activated in order to interrupt the force path. The conveyor carriage 14 which has come to a standstill can now be moved freely.

The subsequent conveyor carriage 14 is moved closer to the conveyor carriage 14 which has come to a standstill until a pushing rubber buffer 50 as a towing and pushing device has made contact with the conveyor carriage which has come to a standstill. In this manner, the following conveyor carriage 14 can now push the conveyor carriage 14 which has come to a standstill out of the dryer portion 18 which is difficult to access.

The system control unit can then redirect the dual pairing onto a maintenance portion of the conveyor path so that the remaining conveyor system 10 can switch back completely into normal operation. Alternatively, defective components can also be replaced at an easily accessible path portion by maintenance operators.

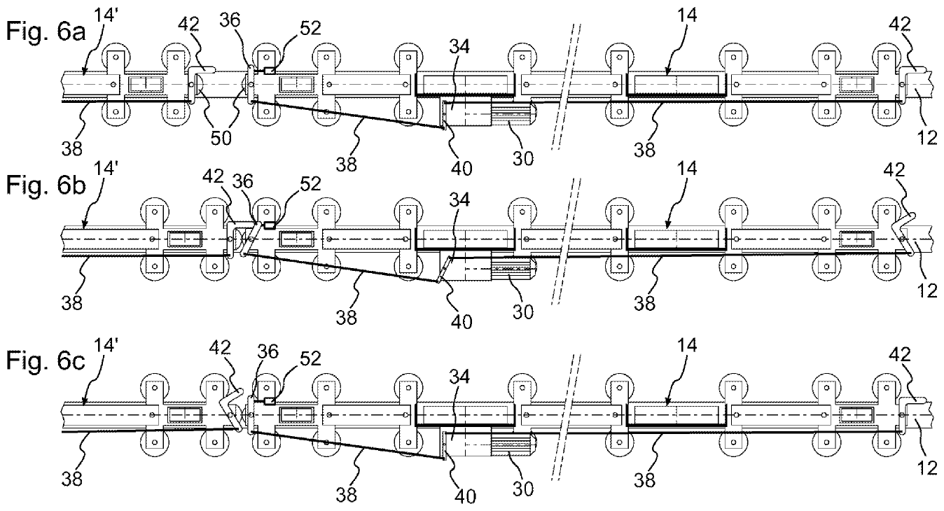

In FIGS. 6a, 6b and 6c, the chassis cut-out of a modified conveyor carriage 14 relevant to the invention is shown in three different situations as a plan view from above of the travel rail 12. Components which are identical or which have the same function are given the same reference numerals.

In this instance, the separation device 34 comprises both at the rear an activation element 36 and at the front an activation element 42 which are both connected to the coupling lever 40 of the separation device 34 by means of articulated rods 38.

As will become clear below, in this modification the activation elements 36, 42 can act both in an active and in a passive manner, that is to say, can activate or be activated.

There is provided on the activation element 36 a spring locking bar 52 which is intended to be unlocked electrically and which during normal operation prevents external activation of the activation element (FIG. 6a).

FIG. 6b shows a situation in which the conveyor carriage 14 shown on the right has come to a standstill. Subsequently, the conveyor carriage 14′ shown on the left was moved closer and the activation element 42 thereof functions as an active activation element 42 and activates the activation element 36 of the conveyor carriage 14 which has come to a standstill. A tilting of the activation element 36 is possible since, as a result of the malfunction, the spring locking bar 52 unlocks and enables an external activation of the separation device 34.

In FIG. 6c, however, the conveyor carriage 14′ shown on the left has come to a standstill. In this instance, the spring locking bar 52 of the conveyor carriage 14 shown on the right is still supplied with electric power and prevents a tilting movement of the activation element 36. Therefore, during movement from the right toward the activation element 42 of the conveyor carriage 14′ shown on the left, it can apply a force and activate it.

The active and passive functions of the activation elements 36, 42 are thus transposed.

In this manner, using simple mechanical means, the separation devices 34 of the conveyor carriages 14, 14′ can be activated both from the front and from the rear.

What is claimed is:

1. A conveyor system comprising:
a) a conveyor path, and
b) at least one conveyor carriage which carries an individual drive and which can be moved therewith along the conveyor path, wherein the drive comprises
drive motor, and
a separation device, by means of which the force path between the drive motor and the conveyor path can be separated,
wherein
c) the separation device is configured to be activated by means of a separation carriage which follows the conveyor carriage along the conveyor path and/or a separation carriage which precedes the conveyor carriage along the conveyor path in order to separate the force path between the drive motor of the at least one conveyor carriage and the conveyor path.

2. The conveyor system as claimed in claim 1, wherein the separation device comprises a passive activation element which is arranged and configured to be activated by a complementary active activation element on the separation carriage.

3. The conveyor system as claimed in claim 2, wherein the active and the passive activation elements cooperate mechanically.

4. The conveyor system as claimed in claim 1, wherein the separation device comprises an electrical actuation drive in order to separate the force path and the conveyor carriage has electrical connection elements which are supplied with electric power by means of complementary electrical connection elements on the separation carriage.

5. The conveyor system as claimed in claim 1, wherein the separation device is a switchable coupling, by means of which the force path between the drive motor and a drive wheel which bears on the conveyor path is separated.

6. The conveyor system as claimed in claim 1, wherein the separation carriage is another conveyor carriage.

7. The conveyor system as claimed in claim 1, wherein, in order to separate the force path, the separation carriage is configured to be moved closer to the conveyor carriage than is the case during normal travel operation.

8. The conveyor system as claimed in claim 1, wherein the drive comprises a plurality of separation devices and all these separation devices are activated at the same time by the separation carriage.

9. The conveyor system as claimed in claim 1, wherein the separation carriage has a towing and/or pushing device by means of which the conveyor carriage can be towed away or pushed with the separation device of the conveyor carriage being activated at the same time.

10. The conveyor system as claimed in claim 1, wherein the separation carriage has a signal transmitter which signals successful activation of the separation device of the conveyor carriage to a control unit.

11. A conveyor carriage which carries an individual drive and which can be moved therewith along a conveyor path, wherein the drive comprises
a) a drive motor, and
b) a separation device, by means of which the force path between the drive motor and the conveyor path can be separated,
wherein
c) the separation device is configured to be activated by a separation carriage which follows the conveyor carriage along the conveyor path and/or a separation carriage which precedes the conveyor carriage along the conveyor path in order to separate the force path between the drive motor of the at least one conveyor carriage and the conveyor path.

12. A method for removing a conveyor carriage which has come to a standstill from a poorly accessible conveyor path portion of a conveyor system comprising the following steps:
a) moving the separation carriage toward the conveyor carriage;
b) separating the force path between the drive motor and conveyor path using the separation carriage; and
c) moving the conveyor carriage out of the poorly accessible conveyor path portion,
wherein the conveyor system comprises a conveyor system of claim 1.
